(19) United States
(12) Patent Application Publication
(10) Pub. No.: US 2011/0182338 A1
(43) Pub. Date: Jul. 28, 2011

(54) CO-CHANNEL INTERFERENCE AND ADJACENT CHANNEL INTERFERENCE DETECTION AND SUPPRESSION

(76) Inventors: Junqiang Li, Irvine, CA (US); Baoguo Yang, San Jose, CA (US)

(21) Appl. No.: 13/003,053

(22) PCT Filed: Jul. 7, 2009
(86) PCT No.: PCT/US2009/049745

§ 371 Date: Apr. 4, 2011

Related U.S. Application Data
(60) Provisional application No. 61/078,507, filed on Jul. 7, 2008.

(51) Int. Cl. H04B 17/00

(52) U.S. Cl. 375/224

(57) ABSTRACT

Methods having corresponding apparatus and computer-readable media comprise: receiving an input signal, wherein the input signal includes a DVB-H signal; detecting co-channel interference (CCI) in the signal; suppressing the CCI in the input signal; and demodulating the DVB-H signal after suppressing the CCI.

### CROSS-REFERENCE TO RELATED APPLICATIONS

This application claims benefit of U.S. Provisional Patent Application Ser. No. 61/078,507 filed Jul. 7, 2008, the disclosure thereof incorporated by reference herein in its entirety.

### FIELD

The present disclosure relates generally to mitigating interference for wireless signals. More particularly, the present disclosure relates to detecting and suppressing co-channel interference and adjacent channel interference in orthogonal frequency-division multiplexing communication systems.

### BACKGROUND

Wireless mobile communications devices such as mobile telephones are now increasingly used to receive and display digital video. Wireless communication technologies are being used to deliver this high-bandwidth content to the mobile devices. One such technology is orthogonal frequency-division multiplexing (OFDM). While capable of delivering video content wirelessly, OFDM is susceptible to co-channel interference (CCI) and adjacent channel interference (ACI), which can significantly impact the performance in OFDM systems such as DVB-H (Digital Video Broadcasting—Handheld).

For DVB-H, the major source of CCI is analog TV signals, and the major source of ACI is adjacent frequency channels. The ACI and CCI significantly degrade the performance of coarse frequency offset estimation and scattered pilot position estimation, thereby reducing the quality of the video delivered to the users of the mobile devices.

### SUMMARY

In general, in one aspect, an embodiment features a method comprising: receiving an input signal, wherein the input signal includes a DVB-H signal; detecting co-channel interference (CCI) in the signal; suppressing the CCI in the input signal; and demodulating the DVB-H signal after suppressing the CCI.

Embodiments of the method can include one or more of the following features. In some embodiments, detecting the CCI in the signal comprises: determining an average power for the input signal; and selecting a peak in a power spectrum of the input signal as the CCI, wherein the selecting is based on the average power and a predetermined threshold. In some embodiments, suppressing the CCI in the input signal comprises: generating a notch filter to remove the CCI from the input signal; and filtering the input signal with the notch filter. Some embodiments comprise detecting ACI in the input signal; and suppressing the ACI in the input signal. In some embodiments, detecting the ACI in the input signal comprises: determining an average power for the input signal; determining a guard band average power for the input signal; generating a ratio of the average power to the guard band average power; and detecting the ACI based on the ratio and a predetermined threshold. In some embodiments, suppressing the ACI in the input signal comprises: generating a bandpass filter to remove the ACI from the input signal; and filtering the input signal with the bandpass filter. Some embodiments comprise displaying video based on the DVB-H signal.

Embodiments of the apparatus can include one or more of the following features. Some embodiments comprise an input module to receive an input signal, wherein the input signal includes a DVB-H signal; a co-channel interference (CCI) detection module to detect CCI in the signal; a CCI suppression module to suppress the CCI in the input signal; and a demodulator to demodulate the DVB-H signal after the CCI suppression module suppresses the CCI in the input signal. In some embodiments, the CCI detection module comprises: an average power module to determine an average power for the input signal; and a peak selection module to select a peak in a power spectrum of the input signal as the CCI based on the average power and a predetermined threshold. In some embodiments, the CCI suppression module comprises: a notch filter to remove the CCI from the input signal. Some embodiments comprise an adjacent channel interference (ACI) detection module to detect ACI in the input signal; and an ACI suppression module to suppress the ACI in the input signal. In some embodiments, the ACI detector comprises: an average power module to determine an average power for the input signal; a guard band average power module to determine a guard band average power for the input signal; and a ratio module to generate a ratio of the average power to the guard band average power; wherein the ACI detection module detects the ACI based on the ratio and a predetermined threshold. In some embodiments, the ACI suppression module comprises: a bandpass filter to remove the ACI from the input signal. Some embodiments comprise a display to display video based on the DVB-H signal. Some embodiments comprise a wireless communication device comprising the apparatus.

In general, in one aspect, an embodiment features computer-readable media embodying instructions executable by a computer to perform a method comprising: detecting co-channel interference (CCI) in a received input signal, wherein the input signal includes a DVB-H signal; suppressing the CCI in the input signal; and demodulating the DVB-H signal after suppressing the CCI. In some embodiments, detecting the CCI in the signal comprises: determining an average power for the input signal; and selecting a peak in a power spectrum of the input signal as the CCI, wherein the selecting is based on the average power and a predetermined threshold. In some embodiments, suppressing the CCI in the input signal comprises: generating a notch filter to remove the CCI from the input signal; and filtering the input signal with the notch filter. In some embodiments, the method further comprises: detecting ACI in the input signal; and suppressing the ACI in the input signal. In some embodiments, detecting the ACI in the input signal comprises: determining an average power for the input signal; determining a guard band average power for the input signal; generating a ratio of the average power to the guard band average power; and detecting the ACI based on the ratio and a predetermined threshold. In some embodiments, suppressing the ACI in the input signal comprises: generating a bandpass filter to remove the ACI from the input signal; and filtering the input signal with the bandpass filter. In some embodiments, the method further comprises: displaying video based on the DVB-H signal.

The details of one or more implementations are set forth in the accompanying drawings and the description below. Other features will be apparent from the description and drawings, and from the claims.

### DESCRIPTION OF DRAWINGS

FIG. 1 shows elements of a wireless data communication system comprising a wireless communication device receiving wireless OFDM signals from a transmitter according to some embodiments.

FIG. 2 shows elements of the wireless communication device of FIG. 1 according to some embodiments.

FIG. 3 shows a process for CCI and ACI detection and suppression for the wireless communication device of FIG. 2 according to some embodiments.

FIG. 4 shows a process for CCI detection and suppression for the wireless communication device of FIG. 2 according to some embodiments.

FIG. 5 shows a process for ACI detection and suppression for the wireless communication device of FIG. 2 according to some embodiments.

The leading digit(s) of each reference numeral used in this specification indicates the number of the drawing in which the reference numeral first appears.

### DETAILED DESCRIPTION

Embodiments of the present disclosure provide detection and suppression of co-channel interference (CCI) and adjacent channel interference (ACI) in receivers of orthogonal frequency-division multiplexing (OFDM) signals. One such OFDM signal is DVB-H (Digital Video Broadcasting—Handheld). Various embodiments are described with reference to DVB-H signals. However, the disclosed techniques apply to other OFDM signals as well, as will be apparent after reading this disclosure.

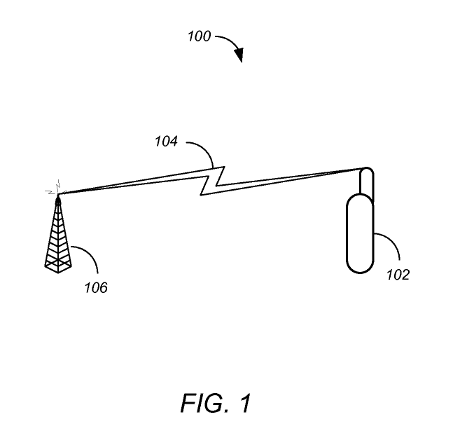

FIG. 1 shows elements of a wireless data communication system 100 comprising a wireless communication device 102 receiving wireless OFDM signals 104 from a transmitter 106 according to some embodiments. Although in the described embodiments, the elements of wireless data communication system 100 are presented in one arrangement, other embodiments may feature other arrangements, as will be apparent to one skilled in the relevant arts based on the disclosure and teachings provided herein. For example, the elements of wireless data communication system 100 can be implemented in hardware, software, or combinations thereof.

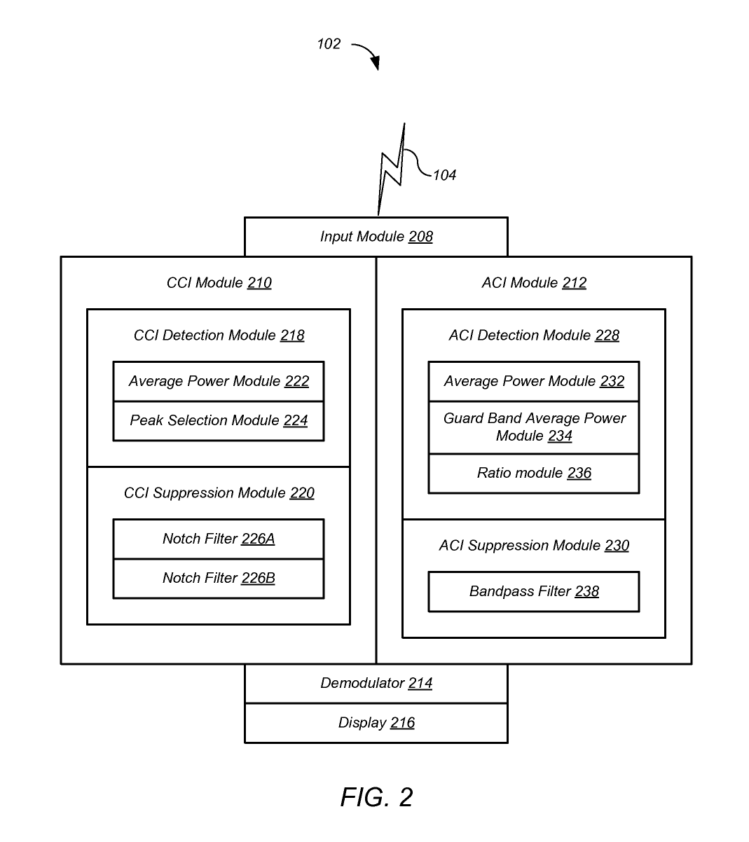

FIG. 2 shows elements of wireless communication device 102 of FIG. 1 according to some embodiments. Although in the described embodiments, the elements of wireless communication device 102 are presented in one arrangement, other embodiments may feature other arrangements, as will be apparent to one skilled in the relevant arts based on the disclosure and teachings provided herein. For example, the elements of wireless communication device 102 can be implemented in hardware, software, or combinations thereof. For example, wireless communication device 102 can be implemented as a mobile phone, a personal digital assistant (PDA), a personal computer, and the like.

Referring to FIG. 2, wireless communication device 102 includes an input module 208 to receive wireless OFDM signals 104, which can include DVB-H signals or the like. Wireless communication device 102 also includes a co-channel interference (CCI) module 210 to detect and suppress CCI in signals 104, an adjacent channel interference (ACI) module 212 to detect and suppress ACI in signals 104, and a demodulator 214 to demodulate signals 104 after suppression of the CCI and/or ACI. Wireless communication device 102 also includes a display 216 to display video based on signals 104.

CCI module 210 includes a CCI detection module 218 to detect CCI in signals 104 and a CCI suppression module 220 to suppress the CCI. CCI detection module 218 includes an average power module 222 to determine an average power for signals 104 and a peak selection module 224 to select a peak in a power spectrum of signal 104 as the CCI based on the average power and a predetermined threshold. CCI suppression module 220 includes one or more notch filters 226 to remove the CCI from signal 104. In the described embodiments, two notch filters 226A and 226B are used. In other embodiments, other numbers of notch filters 226 can be used, as will be apparent after reading this disclosure.

ACI module 212 includes an ACI detection module 228 to detect ACI in signals 104 and an ACI suppression module 230 to suppress the ACI. ACI detection module 228 includes an average power module 232 to determine an average power for signals 104, a guard band average power module 234 to determine a guard band average power for signals 104, and a ratio module 236 to generate a ratio of the average power to the guard band average power. In some embodiments, average power modules 222, 232, and 234 can be implemented as a single module. ACI suppression module 230 includes one or more bandpass filters 238 to remove the ACI from signals 104.

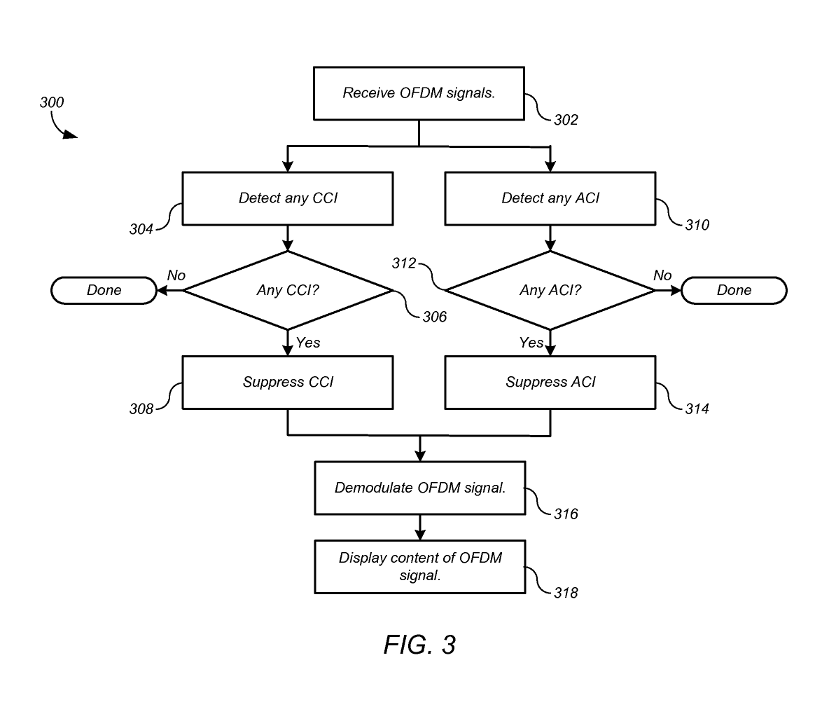

FIG. 3 shows a process 300 for CCI and ACI detection and suppression for wireless communication device 102 of FIG. 2 according to some embodiments. Although in the described embodiments, the elements of the processes disclosed herein are presented in one arrangement, other embodiments may feature other arrangements, as will be apparent to one skilled in the relevant arts based on the disclosure and teachings provided herein. For example, in various embodiments, some or all of the steps of the disclosed processes can be executed in a different order, concurrently, and the like.

Referring to FIG. 3, input module 208 receives signals 104 (step 302). In some embodiments, signals 104 include DVB-H signals. In some embodiments, CCI detection module 218 detects any CCI in signals 104 (step 304). If any CCI is detected (step 306), CCI suppression module 220 suppresses the CCI (step 308). In some embodiments, ACI detection module 228 detects any ACI in signals 104 (step 310). If any ACI is detected (step 312), ACI suppression module 230 suppresses the ACI (step 314). In some embodiments, both CCI and ACI are detected and suppressed. After suppression of any CCI and/or ACI, demodulator 214 demodulates OFDM signal 104 (step 316). Then display 216 can display content of signals 104 such as video and the like (step 318).

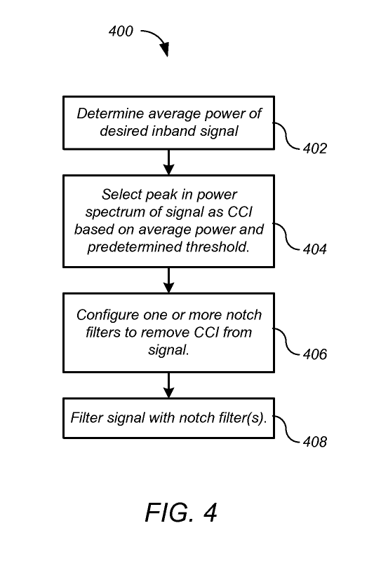

FIG. 4 shows a process 400 for CCI detection and suppression for wireless communication device 102 of FIG. 2 according to some embodiments. Referring to FIG. 4, average power module 222 of CCI detection module 218 determines an average power of the desired inband signal (for example, a DVB-H signal) for signal 104 (step 402). For example, after generating digital data based on signal 104, input module 208 applies an 8k Fast Fourier Transform (FFT) to achieve the frequency spectrum characteristic of signal 104, and filters the result with an infinite impulse response (IIR) filter having a forget factor of 1/4 to obtain a short-term averaged power spectrum over all 8k sub-carriers. The power can be averaged over the whole band (for example, 8 MHz for DVB-H) or measured over the band without the analog TV CCI signals (for example, 2.5 MHz-3.5 MHz for DVB-H). This selection can be configurable.

Next peak selection module 224 selects a peak in the power spectrum of signal 104 as CCI based on the average power and a predetermined threshold (404). The threshold can be programmable. For example, the threshold can be 8 dB, which is about 9 dB above the desired signal. The maximum peak over the whole band with power larger than the product of the threshold and the average power can be considered as the dominant CCI. In some embodiments, the second strongest CCI can be detected to improve performance. The whole band is divided into sub-bands with equal bandwidth (for example, the sub-band width can be 32 sub-carriers, with a total of 256 sub-bands). The sub-band with maximum power that satisfies the threshold requirement can be considered as a second CCI. It should be noted that the sub-band including the first CCI is ignored when detecting the second CCI.

After CCI detection, CCI suppression module 220 configures one or more notch filters 226 to remove the CCI from signal 104 (step 406). For example, CCI suppression module 220 configures notch filter 226A to remove the dominant CCI, and configures notch filter 226B to remove the second CCI. CCI suppression module 220 then filters signals 104 with notch filters 226 (step 408). Each notch filter can be implemented by phase rotation on a real high-pass finite impulse response (FIR) filter based on the detected signal tone frequency position.

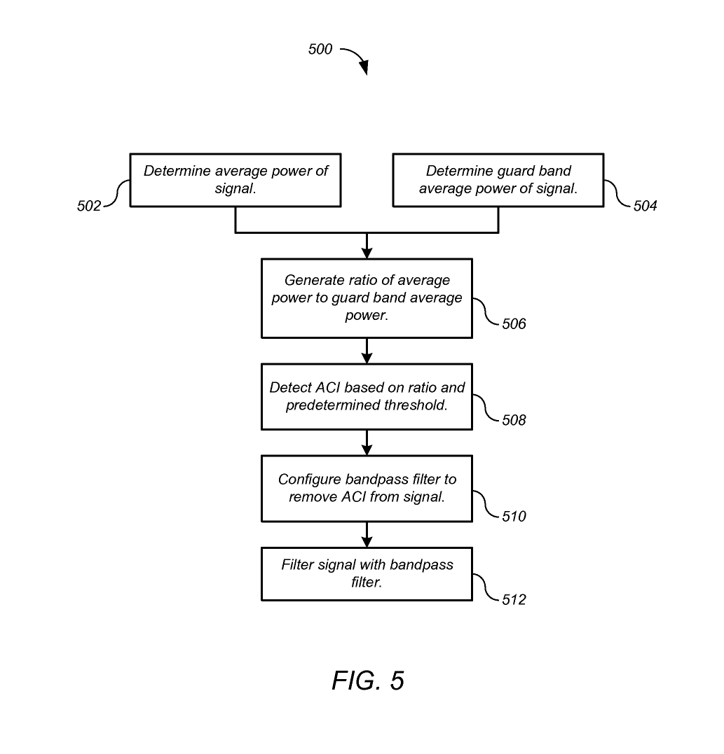

FIG. 5 shows a process 500 for ACI detection and suppression for wireless communication device 102 of FIG. 2 according to some embodiments. ACI is detected based on the ratio between out-of-band spectrum power and inband spectrum power. Referring to FIG. 5, average power module 232 of ACI detection module 228 determines an average power of signal 104 (step 502), for example as described above. Guard band average power module 234 determines a guard band average power for the input signal (step 504), for example according to similar techniques. Ratio module 236 then generates a ratio of the average power to the guard band average power (step 506). ACI detection module 228 then detects the ACI based on the ratio and a predetermined programmable threshold (step 508). For example, the ratio can be 0.5, and ACI is detected when the ratio exceeds the threshold.

After ACI detection, ACI suppression module 230 configures bandpass filter(s) 238 to remove the ACI from signal 104 (step 510). ACI suppression module 230 then filters signals 104 with bandpass filter 238 (step 512).

Embodiments of the disclosure can be implemented in digital electronic circuitry, or in computer hardware, firmware, software, or in combinations of them. Embodiments of the disclosure can be implemented in a computer program product tangibly embodied in a machine-readable storage device for execution by a programmable processor; and method steps of the disclosure can be performed by a programmable processor executing a program of instructions to perform functions of the disclosure by operating on input data and generating output. The disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the disclosure have been described. Nevertheless, it will be understood that various modifications may be made without departing from the spirit and scope of the disclosure. Accordingly, other implementations are within the scope of the following claims.

What is claimed is:

1. A method comprising:
receiving an input signal, wherein the input signal includes a DVB-H signal;
detecting co-channel interference (CCI) in the signal;
suppressing the CCI in the input signal; and
demodulating the DVB-H signal after suppressing the CCI.

2. The method of claim 1, wherein detecting the CCI in the signal comprises:
determining an average power for the input signal; and
selecting a peak in a power spectrum of the input signal as the CCI, wherein the selecting is based on the average power and a predetermined threshold.

3. The method of claim 1, wherein suppressing the CCI in the input signal comprises:
generating a notch filter to remove the CCI from the input signal; and
filtering the input signal with the notch filter.

4. The method of claim 1, further comprising:
detecting ACI in the input signal; and
suppressing the ACI in the input signal.

5. The method of claim 4, wherein detecting the ACI in the input signal comprises:
determining an average power for the input signal;
determining a guard band average power for the input signal;
generating a ratio of the average power to the guard band average power; and
detecting the ACI based on the ratio and a predetermined threshold.

6. The method of claim 4, wherein suppressing the ACI in the input signal comprises:
generating a bandpass filter to remove the ACI from the input signal; and
filtering the input signal with the bandpass filter.

7. The method of claim 1, further comprising:
displaying video based on the DVB-H signal.

8. An apparatus comprising:
an input module to receive an input signal, wherein the input signal includes a DVB-H signal;
a co-channel interference (CCI) detection module to detect CCI in the signal;
a CCI suppression module to suppress the CCI in the input signal; and
a demodulator to demodulate the DVB-H signal after the CCI suppression module suppresses the CCI in the input signal.

9. The apparatus of claim 8, wherein the CCI detection module comprises:
an average power module to determine an average power for the input signal; and
a peak selection module to select a peak in a power spectrum of the input signal as the CCI based on the average power and a predetermined threshold.

10. The apparatus of claim 8, wherein the CCI suppression module comprises:
a notch filter to remove the CCI from the input signal.

11. The apparatus of claim 8, further comprising:
an adjacent channel interference (ACI) detection module to detect ACI in the input signal; and
an ACI suppression module to suppress the ACI in the input signal.

12. The apparatus of claim 11, wherein the ACI detector comprises:
an average power module to determine an average power for the input signal;
a guard band average power module to determine a guard band average power for the input signal; and
a ratio module to generate a ratio of the average power to the guard band average power;
wherein the ACI detection module detects the ACI based on the ratio and a predetermined threshold.

13. The apparatus of claim 11, wherein the ACI suppression module comprises:
a bandpass filter to remove the ACI from the input signal.

14. The apparatus of claim 8, further comprising:
a display to display video based on the DVB-H signal.

15. A wireless communication device comprising the apparatus of claim 14.

16. Computer-readable media embodying instructions executable by a computer to perform a method comprising:
detecting co-channel interference (CCI) in a received input signal, wherein the input signal includes a DVB-H signal;
suppressing the CCI in the input signal; and
demodulating the DVB-H signal after suppressing the CCI.

17. The computer-readable media of claim 16, wherein detecting the CCI in the signal comprises:
determining an average power for the input signal; and
selecting a peak in a power spectrum of the input signal as the CCI, wherein the selecting is based on the average power and a predetermined threshold.

18. The computer-readable media of claim 16, wherein suppressing the CCI in the input signal comprises:
generating a notch filter to remove the CCI from the input signal; and
filtering the input signal with the notch filter.

19. The computer-readable media of claim 16, wherein the method further comprises:
detecting ACI in the input signal; and
suppressing the ACI in the input signal.

20. The computer-readable media of claim 19, wherein detecting the ACI in the input signal comprises:
determining an average power for the input signal;
determining a guard band average power for the input signal;
generating a ratio of the average power to the guard band average power; and
detecting the ACI based on the ratio and a predetermined threshold.

21. The computer-readable media of claim 19, wherein suppressing the ACI in the input signal comprises:
generating a bandpass filter to remove the ACI from the input signal; and
filtering the input signal with the bandpass filter.

22. The computer-readable media of claim 16, wherein the method further comprises:
displaying video based on the DVB-H signal.
